(19) United States
(12) Patent Application Publication
(10) Pub. No.: US 2009/0272808 A1
(43) Pub. Date: Nov. 5, 2009

(54) Imaging module with optical elements of one-piece construction

(76) Inventors: Mark Drzymala, Commack, NY (US); Eric Trongone, Holbrook, NY (US); Chinh Tan, Setauket, NY (US); Ming Yu, South Setauket, NY (US); Heng Zhang, Selden, NY (US)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/150,725

(22) Filed: Apr. 30, 2008

(51) Int. Cl. G06K 7/10

(52) U.S. Cl. 235/462.21; 235/462.42

(57) ABSTRACT

An imaging module for imaging, and a reader for and a method of electro-optically reading, a target, include an aiming assembly having an aiming laser for generating an aiming laser beam, an aiming element for collimating the laser beam, and a pattern-generating element for optically modifying the collimated laser beam to generate a visible aiming light pattern on the target, and an illuminating assembly having an illuminating light source for generating illumination light, and an illuminating element for uniformly illuminating the target with the illumination light. A solid-state imager has an array of image sensors for capturing return illumination light from the target. The pattern-generating element is molded of a one-piece construction with at least one of the aiming and illuminating elements.

### DESCRIPTION OF THE RELATED ART

Solid-state imaging systems or imaging readers, as well as moving laser beam readers or laser scanners, have both been used to electro-optically read targets, such as one-dimensional bar code symbols, particularly of the Universal Product Code (UPC) type, each having a row of bars and spaces spaced apart along one direction, as well as two-dimensional symbols, such as Code 49, which introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786.

The imaging reader includes an imaging module having a solid-state imager with a sensor array of cells or photosensors, which correspond to image elements or pixels in a field of view of the imager, and an imaging lens assembly for capturing return light scattered and/or reflected from the symbol being imaged, and for projecting the return light onto the sensor array to initiate capture of an image of the symbol. Such an imager may include a one- or two-dimensional charge coupled device (CCD) or a complementary metal oxide semiconductor (CMOS) device and associated circuits for producing and processing electronic signals corresponding to a one- or two-dimensional array of pixel information over the field of view.

It is therefore known to use the imager for capturing a monochrome image of the symbol as, for example, disclosed in U.S. Pat. No. 5,703,349. It is also known to use the imager with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

In order to increase the amount of the return light captured by the imager, especially in dimly lit environments, the imaging module generally also includes an illuminating light assembly having a plurality of light sources, e.g., light emitting diodes (LEDs), and a plurality of illuminating elements, e.g., lenses, to uniformly illuminate the symbol with the illumination light for reflection and scattering therefrom.

Although generally satisfactory for its intended purpose, the use of an imaging reader is frustrated, because an operator cannot tell whether the imager, or the reader in which the imager is mounted, is aimed directly at the target symbol, which can be located anywhere within a range of working distances from the reader. The imager is a passive unit and provides no visual feedback to the operator to advise where the imager is aimed.

To alleviate such problems, the prior art proposed in U.S. Pat. No. 6,060,722 an aiming light assembly for an imaging reader. The known aiming light assembly utilizes an aiming light source, e.g., a laser, for generating an aiming laser beam, an aiming element, e.g., a lens, for collimating the laser beam, and a pattern-generating element, such as a diffractive optical element (DOE), a holographic element, or a Fresnel element, for optically modifying the collimated laser beam to generate a visible aiming light interference pattern on the symbol prior to reading, the pattern being useful for framing the field of view of the imager. It is also known to use non-interferometric optical elements to project an aiming line as described in U.S. Pat. No. 6,069,748, which disclosed the use of a toroidal lens to project a single aiming line to guide a cutting tool. U.S. Pat. No. 7,182,260 disclosed the use of a refractive optical element (ROE) having a plurality of refractive structures to generate an aiming light pattern on a symbol, also for framing the field of view of the imager.

As advantageous as an imaging reader has been in reading symbols, it has proven disadvantageous in that it is relatively expensive to manufacture and assemble due to its high number of discrete optical elements that must be separately made of different optical materials, such as glass or plastic, stocked, and optically aligned. Thus, the above-described plurality of illuminating lenses, aiming lens and pattern-shaping optical element comprise many parts that need to be individually manufactured, stocked and assembled in mutual optical alignment, and this represents not only added manufacturing and assembly costs to be minimized, but also, tolerance build-ups among stacked parts to be reduced. Also, these parts occupy non-negligible space in the imaging module and thus contribute to an oversized module that cannot readily fit in an arrangement requiring a more compact reader.

### SUMMARY OF THE INVENTION

One feature of the present invention resides, briefly stated, in an imaging reader or module for, and a method of, imaging a target, such as one- or two-dimensional symbols. The reader or module includes an aiming assembly including an aiming laser, such as a laser diode, for generating an aiming laser beam, an aiming element, such as a lens, for collimating the laser beam, and a pattern-generating element, such as a DOE, a holographic element, a Fresnel element, or an ROE, for optically modifying the collimated laser beam to generate a visible aiming light pattern on the target.

The reader or module further includes an illuminating assembly including an illuminating light source, such as one LED or a plurality of LEDs, for generating illumination light, and an illuminating element, such as one illuminating lens or a plurality of illuminating lenses, for uniformly illuminating the target with the illumination light. A solid-state imager, such as a CCD or a CMOS, has an array of image sensors for capturing return illumination light from the target.

In accordance with one feature of this invention, the pattern-generating element is molded of a one-piece construction with at least one, if not all, of the aiming and illuminating elements or lenses. Also, if a carrier or holder for the pattern-generating element is provided, then the pattern-generating element may also be molded of a one-piece construction with the carrier. Further, if an aperture stop is provided for the collimated laser beam, then the pattern-generating element may also be molded of a one-piece construction with the aperture stop. Advantageously, the one-piece construction is molded of a synthetic plastic material.

The one-piece construction is advantageously a plate that is positioned to lie in a plane generally parallel to a printed circuit board on which the imager is mounted. The module includes a generally parallelepiped support for supporting the assemblies and the imager. The printed circuit board is mounted at a rear side of the support, and the plate is mounted at a front side of the support.

Due to the reduced number of discrete optical elements, it is no longer necessary to individually manufacture, stock and optically align a high number of optical elements. Manufacturing and assembly costs are reduced. Tolerance build-ups among stacked parts are decreased. Also, fewer parts occupy less space in the module and thus contribute to a compact design.

The method of imaging a target is advantageously performed by generating an aiming laser beam, collimating the aiming laser beam with an aiming element, optically modifying the collimated laser beam with a pattern-generating element to generate a visible aiming light pattern on the target, generating illumination light, uniformly illuminating the target with the illumination light with an illuminating element, capturing return illumination light from the target with a solid-state imager having an array of image sensors, and molding the pattern-generating element of a one-piece construction with at least one, if not all, of the aiming and illuminating elements.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a portable imaging reader operative in either a handheld mode, or a hands-free mode, for capturing return light from target symbols;

FIG. 2 is a schematic diagram of various components of the reader of FIG. 1;

FIG. 3 is an exploded perspective view of the components of FIG. 2 arranged in an imaging module in a standardized form factor for use in the reader of FIG. 1 in accordance with the present invention;

FIG. 4 is a top plan view of the module of FIG. 3 after assembly;

FIG. 5 is a perspective view of the module of FIG. 3 after assembly;

FIG. 6 is a diagrammatic view of a first embodiment of an aiming assembly for use in the module of FIG. 3;

FIG. 7 is a diagrammatic view of a second embodiment of an aiming assembly for use in the module of FIG. 3;

FIG. 8 is a diagrammatic view of a third embodiment of an aiming assembly for use in the module of FIG. 3;

FIG. 9 is a diagrammatic view of a fourth embodiment of an aiming assembly for use in the module of FIG. 3;

FIG. 10 is a diagrammatic view of a fifth embodiment of an aiming assembly for use in the module of FIG. 3;

FIG. 11 is a diagrammatic view of a sixth embodiment of an aiming assembly for use in the module of FIG. 3; and

FIG. 12 is a diagrammatic view of a seventh embodiment of an aiming assembly for use in the module of FIG. 3.

### DETAILED DESCRIPTION OF THE PREFERRED EMBODIMENTS

Reference numeral 30 in FIG. 1 generally identifies an imaging reader having a generally vertical window 26 and a gun-shaped housing 28 supported by a base 32 for supporting the imaging reader 30 on a countertop. The imaging reader 30 can thus be used in a hands-free mode as a stationary workstation in which products are slid, swiped past, or presented to, the vertical window 26, or can be picked up off the countertop and held in an operator's hand and used in a handheld mode in which a trigger 34 is manually depressed to initiate imaging of indicia, especially one-dimensional symbols, to be read at far distances from the window 26. In another variation, the base 32 can be omitted, and housings of other configurations can be employed. A cable, as illustrated in FIG. 1, connected to the base 32 can also be omitted, in which case, the reader 30 communicates with a remote host by a wireless link, and the reader is electrically powered by an on-board battery.

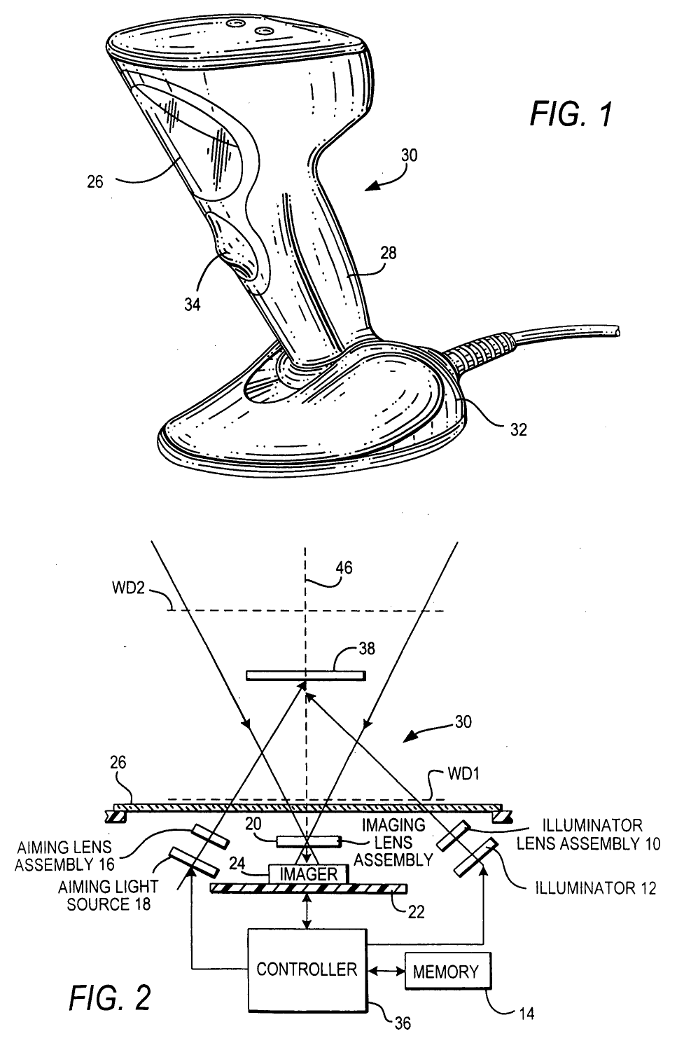

As schematically shown in FIG. 2, an imager 24 is mounted on a printed circuit board 22 in the reader. The imager 24 is a solid-state device, for example, a CCD or a CMOS imager, especially an unpackaged chip, and has a one- or two-dimensional array of addressable image sensors or pixels arranged in a single row or mutually orthogonal rows and columns, and operative for detecting return light captured by an imaging lens assembly 20 along an optical path 46 through the window 26. The return light is scattered and/or reflected from a target or symbol 38 over a field of view. The imaging lens assembly 20 is operative for adjustably focusing the return light onto the array of image sensors to enable the symbol 38 to be read. The symbol 38 is located anywhere in a working range of distances between a close-in working distance (WD1) and a far-out working distance (WD2). In a preferred embodiment, WD1 is about four to six inches from the imager array 24, and WD2 can be many feet from the window 26, for example, around fifty feet away.

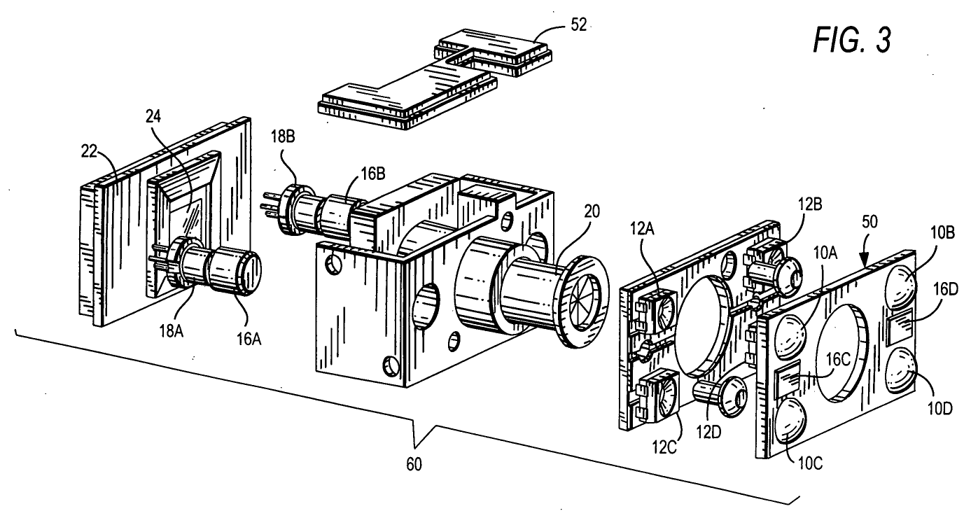

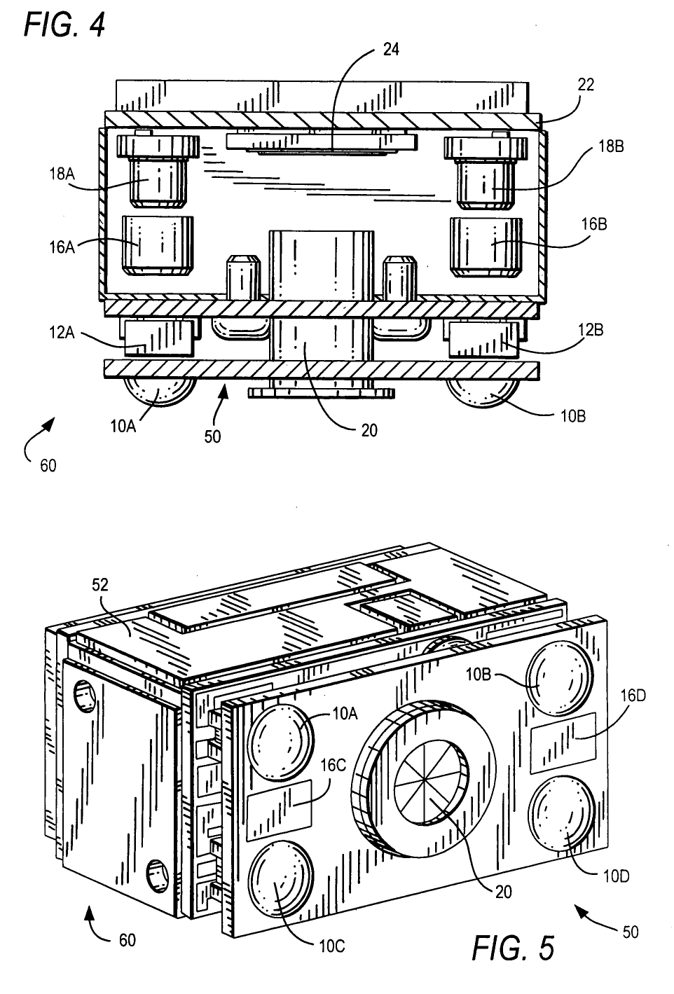

An illuminating assembly is also mounted in the imaging reader and preferably includes a plurality of illuminators or light sources 12, e.g., light emitting diodes (LEDs), and an illuminating lens assembly that includes a plurality of illuminating lenses 10, one for each LED 12, to uniformly illuminate the symbol 38. The illuminating assembly, as best seen in FIGS. 3-5, includes a plurality of LEDs 12A, 12B, 12C, 12D and a plurality of illuminating lenses 10A, 10B, 10C, 10D.

An aiming assembly is also mounted in the imaging reader and preferably includes one aiming light source 18 or a plurality of aiming light sources or aiming lasers 18A, 18B (see FIGS. 3-5), and an aiming lens assembly 16 for generating an aiming beam pattern. The aiming lens assembly 16 includes a plurality of aiming elements, such as lenses 16A, 16B, for collimating the respective laser beams, and a plurality of pattern-generating elements 16C, 16D, each pattern-generating element being a DOE, a holographic element, a Fresnel element, or an ROE, for optically modifying the respective collimated laser beams to generate a visible aiming light pattern on the target.

As shown in FIG. 2, the imager 24, the illuminator 12 and the aiming light source 18 are operatively connected to a controller or microprocessor 36 operative for controlling the operation of these components. A memory 14 is connected and accessible to the controller 36. Preferably, the microprocessor is the same as the one used for processing the return light from target symbols and for decoding the captured target images.

In operation, the microprocessor 36 sends a command signal to energize the aiming light source 18 prior to reading, and also pulses the illuminator 12 for a short exposure time period, say 500 microseconds or less, and energizes and exposes the imager 24 to collect light, e.g., illumination light and/or ambient light, from a target symbol only during said exposure time period. A typical array needs about 33 milliseconds to acquire the entire target image and operates at a frame rate of about 30 frames per second.

In accordance with one feature of this invention, the pattern-generating elements 16C, 16D, the aiming elements 16A, 16B and the illuminating elements 10A, 10B, 10C, 10D are not manufactured as separate optical elements made of different glass or plastic materials, but instead, the pattern-generating elements 16C, 16D are molded of the same material, e.g., plastic, in a one-piece construction with at least one of the aiming elements 16A, 16B and the illuminating elements 10A, 10B, 10C, 10D, and preferably of all the aiming elements 16A, 16B and the illuminating elements 10A, 10B, 10C, 10D.

The one-piece construction is advantageously a plate 50 that is positioned to lie in a plane generally parallel to the plane of the printed circuit board 22 on which the imager 24 is mounted. An anti-reflective coating may be applied on the front surface of the plate 50 in all areas except where the pattern-generating elements 16C, 16D, the aiming elements 16A, 16B and the illuminating elements 10A, 10B, 10C, 10D are located. As previously mentioned, imaging readers having different housing configurations can be used. To that end, another feature of this invention resides in providing a compact imaging module of a form factor standardized to fit in diverse housings of different shapes. Thus, as shown in FIGS. 3-5, an imaging module 60 is designed to have a standardized form factor measuring about 16 millimeters by about 21 millimeters by about 11 millimeters. The module is a generally parallelepiped support for supporting the assemblies and the imager. The printed circuit board 22 is mounted at a rear side of the support, and the plate 50 is mounted at a front side of the support. A top wall 52, preferably another printed circuit board, overlies and closes the top of the module.

Due to the reduced number of discrete optical elements, it is no longer necessary to individually manufacture, stock and optically align a high number of optical elements. Manufacturing and assembly costs are reduced. Tolerance build-ups among stacked parts are decreased. Also, fewer parts occupy less space in the module and thus contribute to a compact design.

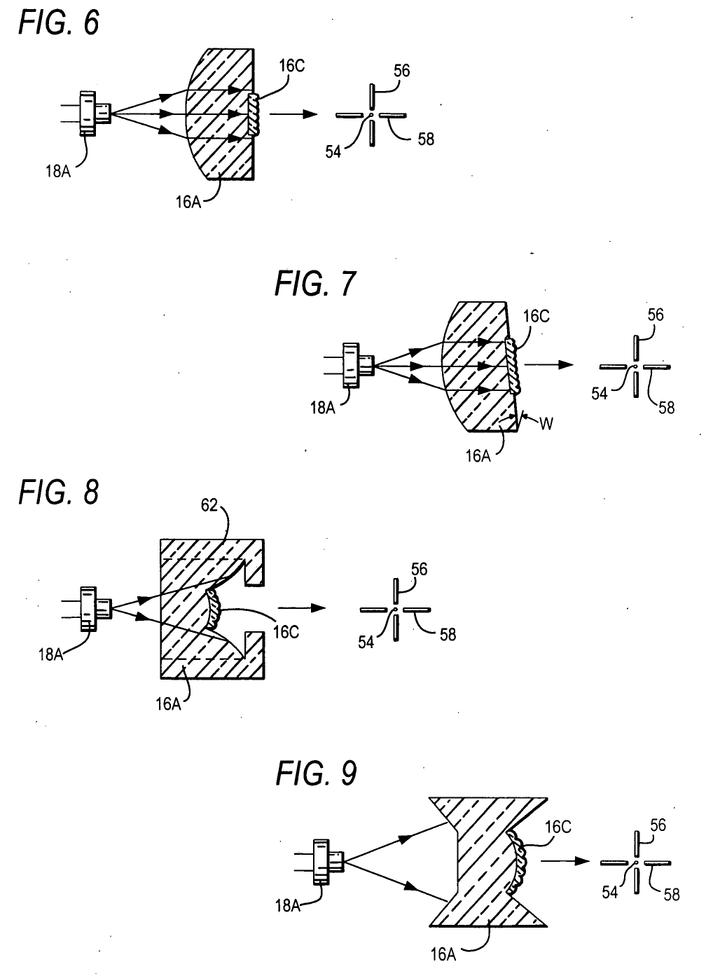

FIGS. 6-12 illustrate various embodiments of the aiming assembly having a representative aiming laser 18A, a representative aiming lens 16A, and a representative pattern-forming element 16C for projecting an aiming pattern comprised of a central spot 54 of light at the intersection of horizontal and vertical framing lines 56, 58, with the aiming lens 16A and the pattern-forming element 16C being formed as a single optical part.

Thus, as shown in FIGS. 6-7, the pattern-forming element 16C is etched directly on the exit surface of the aiming lens 16A. In FIG. 6, the exit surface is vertical. In FIG. 7, the exit surface lies in a plane inclined at an acute wedge angle W to the vertical.

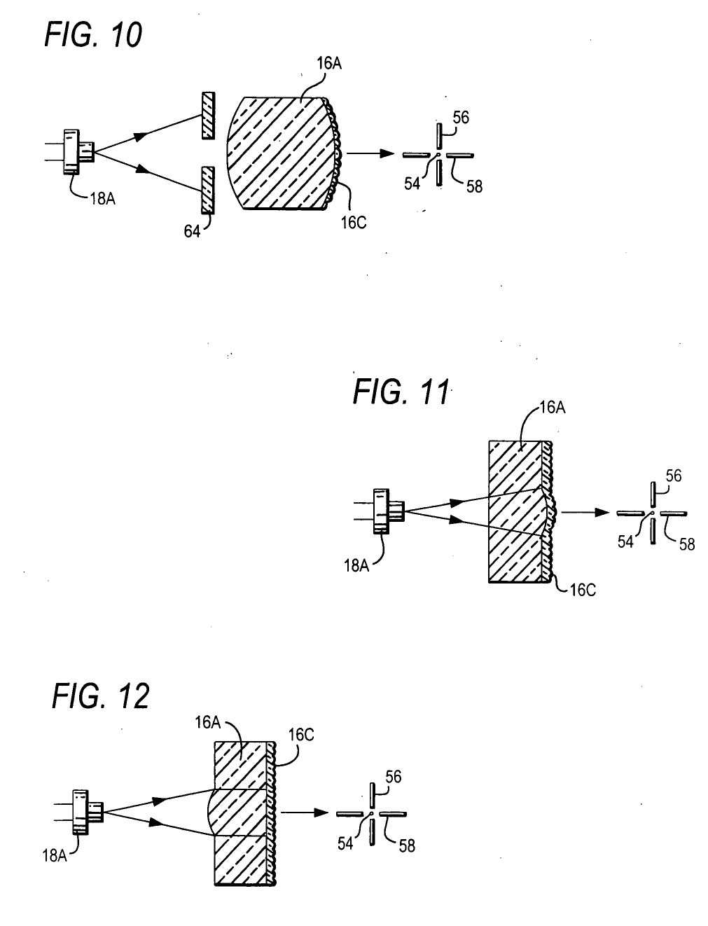

In FIGS. 8-10, the exit surface is convex. In FIG. 8, the combined aiming lens 16A and the pattern-forming element 16C are held in a carrier or holder 62. The combined aiming lens 16A and the pattern-forming element 16C are advantageously molded in a one-piece construction with the carrier 62. The entrance surface of the aiming lens 16A is shorter in FIG. 9 than in FIG. 8. In FIG. 10, a hard aperture stop 64 is provided for the laser beam. The aperture stop 64 could be formed as a coating on the combined aiming lens 16A and the pattern-forming element 16C, in which case, the combined element is molded in a one-piece construction with the aperture stop.

In FIGS. 11-12, the aiming lens 16A is a Fresnel lens, and the combined Fresnel lens 16A and the pattern-forming element 16C are molded in a one-piece construction. In FIG. 11, the entrance surface is vertical. In FIG. 12, the entrance surface is convex.

It will be understood that each of the elements described above, or two or more together, also may find a useful application in other types of constructions differing from the types described above. Thus, a single aiming assembly, rather than the two illustrated aiming assemblies may be employed. Also, two illuminating assemblies, rather than the four illustrated illuminating assemblies may be employed. The illustrated aiming pattern is merely exemplary, and many other aiming patterns may be projected.

While the invention has been illustrated and described as an imaging reader or module having some or all of its optical elements made of a one-piece construction, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

We claim:

1. An imaging module for imaging a target, comprising:
an aiming assembly including an aiming laser for generating an aiming laser beam, an aiming element for collimating the laser beam, and a pattern-generating element for optically modifying the collimated laser beam to generate a visible aiming light pattern on the target;
an illuminating assembly including an illuminating light source for generating illumination light, and an illuminating element for uniformly illuminating the target with the illumination light;
a solid-state imager having an array of image sensors for capturing return illumination light from the target; and
the pattern-generating element being molded of a one-piece construction with at least one of the aiming and illuminating elements.

2. The module of claim 1, wherein the aiming element is an aiming lens.

3. The module of claim 1, wherein the pattern-generating element is a diffractive optical element.

4. The module of claim 1, wherein the pattern-generating element is a refractive optical element.

5. The module of claim 1, wherein the aiming lens assembly includes a carrier for the pattern-generating element, and wherein the pattern-generating element is molded of a one-piece construction with the carrier.

6. The module of claim 1, wherein the aiming lens assembly includes an aperture stop for the collimated laser beam, and wherein the pattern-generating element is molded of a one-piece construction with the aperture stop.

7. The module of claim 1, and a printed circuit board on which the imager is mounted, and wherein the one-piece construction is a plate lying in a plane generally parallel to the printed circuit board.

8. The module of claim 7, wherein the aiming assembly includes an additional aiming element and an additional pattern-generating element, wherein the illuminating assembly includes an additional illuminating element, and wherein the plate is of one-piece with all the pattern-generating, aiming and illuminating elements.

9. The module of claim 1, and a generally parallelepiped support for supporting the assemblies and the imager, wherein the support includes a printed circuit board on which the imager is mounted at a rear side of the support, and wherein the one-piece construction is a plate lying in a plane generally parallel to the printed circuit board at a front side of the support.

10. An imaging module for imaging a target, comprising:
aiming means including an aiming laser for generating an aiming laser beam, an aiming element for collimating the laser beam, and a pattern-generating element for optically modifying the collimated laser beam to generate a visible aiming light pattern on the target;
illuminating means including an illuminating light source for generating illumination light, and an illuminating element for uniformly illuminating the target with the illumination light;
means for capturing return illumination light from the target with a solid-state imager having an array of image sensors; and
the pattern-generating element being molded of a one-piece construction with at least one of the aiming and illuminating elements.

11. An imaging reader for electro-optically reading a target, comprising:
a housing; and
an imaging module supported by the housing, the module including an aiming assembly including an aiming laser for generating an aiming laser beam, an aiming element for collimating the laser beam, and a pattern-generating element for optically modifying the collimated laser beam to generate a visible aiming light pattern on the target; an illuminating assembly including an illuminating light source for generating illumination light, and an illuminating element for uniformly illuminating the target with the illumination light; a solid-state imager having an array of image sensors for capturing return illumination light from the target; and the pattern-generating element being molded of a one-piece construction with at least one of the aiming and illuminating elements.

12. A method of imaging a target, comprising the steps of:
generating an aiming laser beam, collimating the aiming laser beam with an aiming element, and optically modifying the collimated laser beam with a pattern-generating element to generate a visible aiming light pattern on the target;
generating illumination light, and uniformly illuminating the target with the illumination light with an illuminating element;
capturing return illumination light from the target with a solid-state imager having an array of image sensors; and
molding the pattern-generating element of a one-piece construction with at least one of the aiming and illuminating elements.

13. The method of claim 12; and the step of configuring the aiming element as an aiming lens.

14. The method of claim 12; and the step of configuring the pattern-generating element as a diffractive optical element.

15. The method of claim 12; and the step of configuring the pattern-generating element as a refractive optical element.

16. The method of claim 12; and the step of carrying the pattern-generating element in a carrier, and wherein the molding step is performed by molding the pattern-generating element of one-piece with the carrier.

17. The method of claim 12; and the step of providing an aperture stop for the collimated laser beam, and wherein the molding step is performed by molding the pattern-generating element of one-piece with the aperture stop.

18. The method of claim 12; and the step of mounting the imager on a printed circuit board, and wherein the molding step is performed by molding the one-piece construction as a plate lying in a plane generally parallel to the printed circuit board.

19. The method of claim 18; and the step of providing an additional aiming element, an additional pattern-generating element, and an additional illuminating element, and wherein the molding step is performed by molding the plate of one-piece with all the pattern-generating, aiming and illuminating elements.

20. The method of claim 12; and the step of providing a generally parallelepiped support; and the step of mounting the imager on a printed circuit board at a rear side of the support, and wherein the molding step is performed by molding a plate lying in a plane generally parallel to the printed circuit board at a front side of the support.
